(19) United States
(12) Patent Application Publication
(10) Pub. No.: US 2006/0138946 A1
(43) Pub. Date: Jun. 29, 2006

(54) Electrical device with a low reflectivity layer

(76) Inventors: Jian Wang, Goleta, CA (US); Runguang Sun, Shanghai (CN); Gang Yu, Santa Barbara, CA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/025,102

(22) Filed: Dec. 29, 2004

(51) Int. Cl. H05B 33/00; H05B 33/26

(52) U.S. Cl. 313/506; 313/503; 313/509

(57) ABSTRACT

An electrical device has a substrate including a transmissive low reflectivity layer; a first conductor on the substrate; an active material on the first conductor; and a second conductor on the active material. The transmissive low reflectivity layer may be moisture penetrating. The substrate may be flexible or rigid.

### FIELD OF THE INVENTION

The present invention relates generally to electrical devices, and more particularly, to an array of organic electrical devices having improved contrast characteristics through the use of a low reflectivity layer.

### BACKGROUND OF THE INVENTION

Electrical devices, for example, organic light-emitting diodes (OLEDs), are used in a variety of applications, including, for example, flat panel displays. The devices include a plurality of layers including an anode layer, an active layer, and a cathode layer, and may include a hole-transport layer, an electron-injection layer, or both. In OLEDs, the cathode may be made of low work function metals, for example, Mg—Ag alloy, Al—Li alloy, Ca/Al, Ba/Al and LiF/Al bilayers, and has a mirror-like reflectivity if the thickness is over 20 nanometers. The high reflectivity of the cathode results in poor readability or low contrast of the devices in lighted environments.

To reduce the reflectivity, a circular polarizer may be used. However, circular polarizers block about 60% of the emitted light from the device and also considerably increase thickness and the cost of manufacturing.

To improve display contrast, an interfering mechanism such as a high contrast interference film may be disposed between an organic active layer and either the anode layer or the cathode layer. The interfering mechanism is limited to a specific wavelength. The actual contrast ratio of the device not only depends on the ambient light, but also on the emitted light from the device. Integration of such technology in a full color display and making the final product viable in variable lighted environments adds manufacturing complexity and reduces yields, and may result in performance degradation of the device.

To improve display contrast, a light absorbing material between pixels of a display may also be used, wherein the light absorbing material effectively lies within the substrate. However, light-absorbing materials disposed within the substrate may not provide optimal contrast.

There remains a need for an organic electrical device with improved contrast characteristics.

### SUMMARY OF THE INVENTION

In one embodiment, an electrical device includes a substrate including a transmissive low reflectivity moisture penetrating layer; a first conductor on the substrate; an active material on the first conductor; and a second conductor on the active material.

In another embodiment, an electrical device includes a rigid substrate comprising a transmissive low reflectivity layer; a first conductor on the rigid substrate; an active material on the first conductor; and a second conductor on the active material.

In another embodiment, an electrical device includes a substrate including a transmissive low reflectivity layer; the low reflectivity layer having a selected thickness determined by the desired degree of non-reflectance of the desired electromagnetic radiation to be transmitted through the substrate; a first conductor on the substrate; an active material on the first conductor; and a second conductor on the active material.

The foregoing general description and the following detailed description are exemplary and explanatory only and are not restrictive of the invention, as defined in the appended claims.

### BRIEF DESCRIPTION OF THE DRAWINGS

This invention is illustrated by way of example and not limitation in the accompanying figures.

FIG. 1 is a cross-sectional view of a portion of an array of electrical devices that include a low reflectivity layer in an embodiment.

FIG. 2 is a cross sectional view of a portion of an embodiment of an electrical device.

FIG. 3 is a cross sectional view of a portion of another embodiment of an electrical device.

It is to be appreciated that certain features of the invention which are, for clarity, described above and below in the context of separate embodiments, may also be provided in combination in a single embodiment. Conversely, various features of the invention that are, for brevity, described in the context of a single embodiment, may also be provided separately or in any combination. Further, reference to values stated in ranges includes each and every value within that range. It is to be understood that the elements in the figures are not necessarily drawn to scale. For example, the dimensions of some of the elements in the figures may be exaggerated relative to other elements to assist in an understanding of the embodiments of the invention.

Other features and advantages of the invention will be apparent from the following detailed description and from the claims.

### DETAILED DESCRIPTION OF THE INVENTION

In one embodiment, an electrical device includes a substrate including a transmissive low reflectivity moisture penetrating layer; a first conductor on the substrate; an active material on the first conductor; and a second conductor on the active material. The active material is an organic active material. The electrical device may be a display device, or a photodetector device. The low reflectivity layer may be substantially surrounded by the substrate. The low reflectivity layer may also be disposed on a surface of the substrate between the substrate and the first conductor.

In another embodiment, an electrical device includes a rigid substrate comprising a transmissive low reflectivity layer; a first conductor on the rigid substrate; an active material on the first conductor; and a second conductor on the active material. The active material is an organic active material. The electrical device may be a display device or a photodetector device. The rigid substrate may be glass, and the low-reflectivity layer is substantially surrounded by the glass substrate. The glass substrate may also include a low reflectivity layer disposed on a surface of the glass substrate between the glass substrate and the first conductor.

In another embodiment, an electrical device includes a substrate including a transmissive low reflectivity layer; the low reflectivity layer having a selected thickness determined by the desired degree of non-reflectance of the desired electromagnetic radiation to be transmitted through the substrate; a first conductor on the substrate; an active material on the first conductor; and a second conductor on the active material. The active material is an organic active material. The electrical device may be a display device or a photodetector device. The low reflectivity layer may be substantially surrounded by the substrate. The low reflectivity layer may also be on a surface of the substrate between the substrate and the first conductor.

1. Definitions

Before addressing details of embodiments described below, some terms are defined below.

As used herein, the term “active” when referring to a layer or material is intended to mean a layer or material that exhibits electro-radiative properties. An active layer material may emit radiation or exhibit a change in concentration of electron-hole pairs when receiving radiation.

The terms “array,” “peripheral circuitry” and “remote circuitry” are intended to mean different areas or components of the organic electronic device. For example, an array may include pixels, cells, or other structures within an orderly arrangement (usually designated by columns and rows). The pixels, cells, or other structures within the array may be controlled locally by peripheral circuitry, which may lie within the same organic electronic device as the array but outside the array itself. Remote circuitry typically lies away from the peripheral circuitry and can send signals to or receive signals from the array (typically via the peripheral circuitry). The remote circuitry may also perform functions unrelated to the array. The remote circuitry may or may not reside on the substrate having the array.

The term “charge transport” when referring to a layer, material, member, or structure is intended to mean such layer, material, member, or structure facilitates migration of such charge through the thickness of such layer, material, member, or structure with relative efficiency and small loss of charge.

The term “continuous” and its variants are intended to mean substantially unbroken. In one embodiment, continuously printing is printing using a substantially unbroken stream of a liquid or a liquid composition, as opposed to a depositing technique using drops. In another embodiment, extending continuously refers to a length of a layer, member, or structure in which no significant breaks in the layer, member, or structure lie along its length.

The term “electron withdrawing” is synonymous with “hole injecting.” Literally, holes represent a lack of electrons and are typically formed by removing electrons, thereby creating an illusion that positive charge carriers, called holes, are being created or injected. The holes migrate by a shift of electrons, so that an area with a lack of electrons is filled with electrons from an adjacent layer, which give the appearance that the holes are moving to that adjacent area. For simplicity, the terms holes, hole injecting, hole transport, and their variants will be used.

The term “emission maximum” is intended to mean the highest intensity of radiation emitted. The emission maximum has a corresponding wavelength or spectrum of wavelengths (e.g. red light, green light, or blue light).

The term “essentially X” is intended to mean that the composition of a layer or material is mainly X but may also contain other ingredients that do not detrimentally affect the functional properties of that layer or material to a degree at which the layer or material can no longer perform its intended purpose.

The term “high absorbance” when used to modify a layer or material is intended to mean no more than approximately 10% of the radiation at a targeted wavelength or spectrum is transmitted through the layer or material.

The term “high work function” when referring to a layer or material is intended to mean a layer or material having a work function of at least approximately 4.4 eV.

The term “layer” is used interchangeably with the term “film” and refers to a coating covering a desired area. The term is not limited by size. The area can be as large as the entire device or as small as a specific functional area such as the actual visual display, or as small as a single sub-pixel. Layers and films can be formed by any conventional deposition technique, including vapor deposition and liquid deposition (continuous and discontinuous techniques) and thermal transfer. Continuous deposition techniques include, but are not limited to, spin coating, gravure coating, curtain coating, dip coating, slot-die coating, spray coating, and continuous nozzle coating. Discontinuous deposition techniques include, but are not limited to ink jet printing, gravure printing, and screen printing.

The term “low reflectivity” when referring to a layer or material is intended to mean that the layer or material that reflects no more than approximately 30% of radiation at the targeted wavelength or spectrum of wavelengths. In the case of light, the radiation of the targeted spectrum is visible spectrum (wavelengths of approximately 400-700 nm) and a targeted wavelength may be approximately 540 nm.

The term “low work function” when referring to a layer or material is intended to mean a layer or material having a work function no greater than about 4.4 eV.

The term “most” is intended to mean more than half.

The term “on” as in A “on” B shall mean, either directly “on”, i.e. A in physical contact with B, or A is indirectly in contact with B, through another material or layer.

The term “organic electronic device” or “electronic device” is intended to mean a device including one or more organic semiconductor layers or materials. An organic electronic device includes, but is not limited to: (1) a device that converts electrical energy into radiation (e.g., a light-emitting diode, light emitting diode display, diode laser, or lighting panel), (2) a device that detects a signal using an electronic process (e.g., a photodetector, a photoconductive cell, a photoresistor, a photoswitch, a phototransistor, a phototube, an infrared (“IR”) detector, or a biosensors), (3) a device that converts radiation into electrical energy (e.g., a photovoltaic device or solar cell), (4) a device that includes one or more electronic components that include one or more organic semiconductor layers (e.g., a transistor or diode), or any combination of devices in items (1) through (4).

The term “pixel” is intended to mean the smallest complete, repeating unit of an array. The term “subpixel” is intended to mean a portion of a pixel that makes up only a part, but not all, of a pixel. In a full-color display, a full-color pixel can comprise three sub-pixels with primary colors in red, green and blue spectral regions. A monochromatic display may include pixels but no subpixels. A sensor array can include pixels that may or may not include subpixels.

The term “primary surface” is intended to mean a surface of a substrate from which an electronic component is subsequently formed.

The term “radiation-emitting component” is intended to mean an electronic component, which when properly biased, emits radiation at a targeted wavelength or spectrum of wavelengths. The radiation may be within the visible-light spectrum or outside the visible-light spectrum (ultraviolet (UV) or infrared (IR)). A light-emitting diode is an example of a radiation-emitting component.

The term “radiation-responsive component” is intended to mean an electronic component can sense or otherwise respond to radiation at a targeted wavelength or spectrum of wavelengths. The radiation may be within the visible-light spectrum or outside the visible-light spectrum (UV or IR). Photodetectors, IR sensors, biosensors, and photovoltaic cells are examples of radiation-responsive components.

The term “user side” is intended to mean a side of an electrical device principally used during normal operation of the electrical device. In the case of a display, the side of the electrical device seen by a user would be a user side. In the case of a sensor or photovoltaic cell, the user side would be the side that principally receives radiation that is to be sensed or converted to electrical energy. Note that an electronic device may have more than one user side.

The term “visible light spectrum” is intended to mean a radiation spectrum having wavelengths corresponding to approximately 400-700 nm.

The term “within” shall mean either a first layer or material is embedded entirely in a second layer or material, such as a substrate, as in the case of first layer or material being substantially surrounded by the substrate, or the first layer is in contact on only one side with the substrate.

Group numbers corresponding to columns within the periodic table of the elements use the “New Notation” convention as seen in the CRC Handbook of Chemistry and Physics, 81st Edition (2000).

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present). Also, use of the “a” or “an” are employed to describe elements and components of the invention. This is done merely for convenience and to give a general sense of the invention. This description should be read to include one or at least one and the singular also includes the plural unless it is obvious that it is meant otherwise.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

To the extent not described herein, many details regarding specific materials, processing acts, and circuits are conventional and may be found in textbooks and other sources within the organic light-emitting diode display, photodetector, photovoltaic, and semiconductor arts.

2. Optical Principles

Before turning to the embodiments, some optical principles are addressed to improve clarity of the description. To quantitatively characterize the contrast of OLED devices, Contrast Ratio, “CR”, is introduced using the following equation:

$$CR = \frac{{L}_{ON} + {L}_{background}}{{L}_{OFF} + {L}_{background}} . \qquad ( Equation 1 )$$

LON is the luminance of a turned-on OLED device and is generally set at 200 Cd/m2. LOFF is the luminance of an off OLED device. Lbackground is the reflected ambient light from the device. CR is dependent on the luminance of the surroundings. For a bright environment, e.g. under direct sun, the contrast ratio is lower than that measured under low-light conditions. In the flat panel display industry, two standard tests are used for the contrast ratio. One is the Dark Room Contrast Ratio, and the other is the Ambient Contrast Ratio. The experimental set-up and procedures are detailed in “Flat Panel Display Measurements Standard” by the Video Electronics Standards Association Display Metrology Committee (“VESA”). In the following examples, the contrast ratios referred to within this specification are obtained using the conditions set in the Ambient Contrast Ratio test.

Contrast can be improved by getting Lbackground as close to zero as possible. In one embodiment, the electrical device may have Lbackground that is no more than approximately 30% of the incident ambient light, Lincident, reaching the device. In other embodiments, Lbackground may be only approximately 10% or even 1% percent of Lincident. One way to reduce Lbackground is to use materials that absorb as much ambient radiation as possible, reflect as little ambient radiation as possible, or use a combination of high absorbance and low reflectance. Note that the electrical device may include many different layers, and therefore, each of the layers individually or in any combination may need to be examined.

3. Organic Electronic Device

Reference is now made in detail to exemplary embodiments which are illustrated in the accompanying drawings. Wherever possible, the same reference numbers will be used throughout the drawings to refer to the same or like parts (elements).

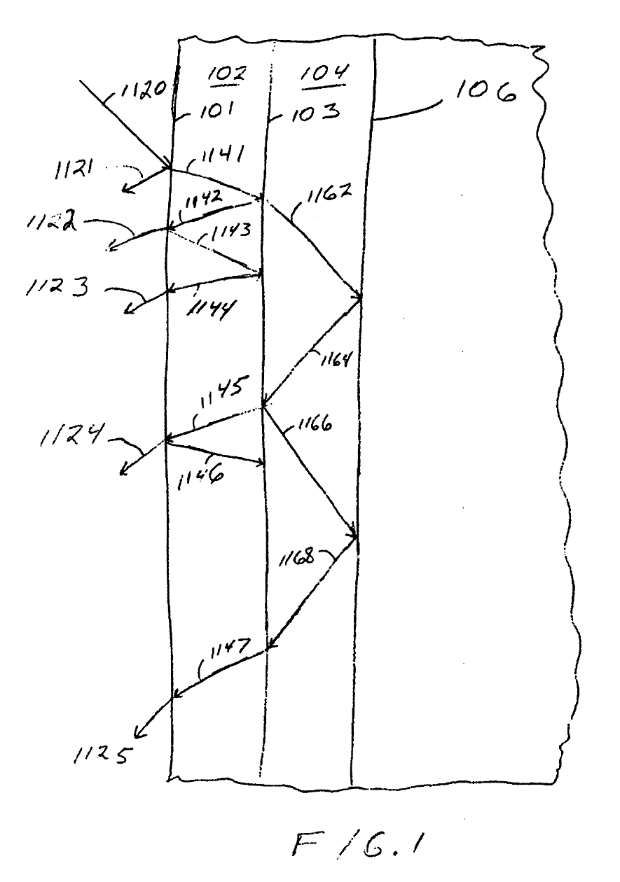

FIG. 1 illustrates the concepts of absorbance and reflectance. FIG. 1 includes a first layer 102, a second layer 104, and a mirror-like surface 106. Incident radiation 1120, Lincident, may be reflected at surface 101 as radiation 1121, or be at least partially transmitted, illustrated as radiation 1141. At the interface 103 between the first and second layers 102 and 104, radiation 1141 may be reflected towards surface 101 as radiation 1142. Radiation 1142 may be transmitted out of the device as radiation 1122 or reflected at surface 101 as illustrated as radiation 1143, which may be reflected at interface 103 as radiation 1144 and emitted as radiation 1123. Although not shown, some of radiation 1143 is at least partially transmitted though layer 104. The radiation can continue to pass along layer 102 similar to a waveguide but such radiation is not illustrated in FIG. 1.

Note that at least some of the radiation is absorbed by layer 102 each time it passes through the layer. Also, some of the radiation reaching interface 103 can enter layer 104. Therefore, radiation 1121 has a greater intensity than radiation 1122, which has a greater intensity than radiation 1123.

Still referring to FIG. 1, at least part of radiation 1141 may be transmitted through the layer 104, illustrated as radiation 1162. Because radiation 1162 reaches the mirror-like surface 106, nearly all radiation that reaches the surface 106 is reflected as illustrated by radiation 1164. At the interface 103, part of radiation 1164 may be reflected as illustrated by radiation 1166 or transmitted through the layer 102 as illustrated by radiation 1145. Similar to the layer 102, the layer 104 may act as a waveguide and include radiation 1166, 1168, and other radiation, not shown.

Some of the radiation that is transmitted through layer 102 (illustrated by arrows 1145 and 1147) may be emitted as illustrated by radiation 1124 and 1125. Part of radiation 1145 is reflected at surface 101 as illustrated by arrow 1146. Note that the “bouncing” of the radiation within a layer and transmission or emission from a layer can continue but is not illustrated in FIG. 1.

If only absorbance of layer 102 is considered, reflected radiation 1121 may be too high. If only low reflectivity of the first layer 102 is considered, radiation passing through the second layer 104 and reflected by surface 106 and re-emitted from the device (see radiation 1141, 1162, 1164, 1145, and 1124) may be too high. Therefore, both reflectivity and absorbance for all layers may be considered to ensure that Lbackground can be minimized.

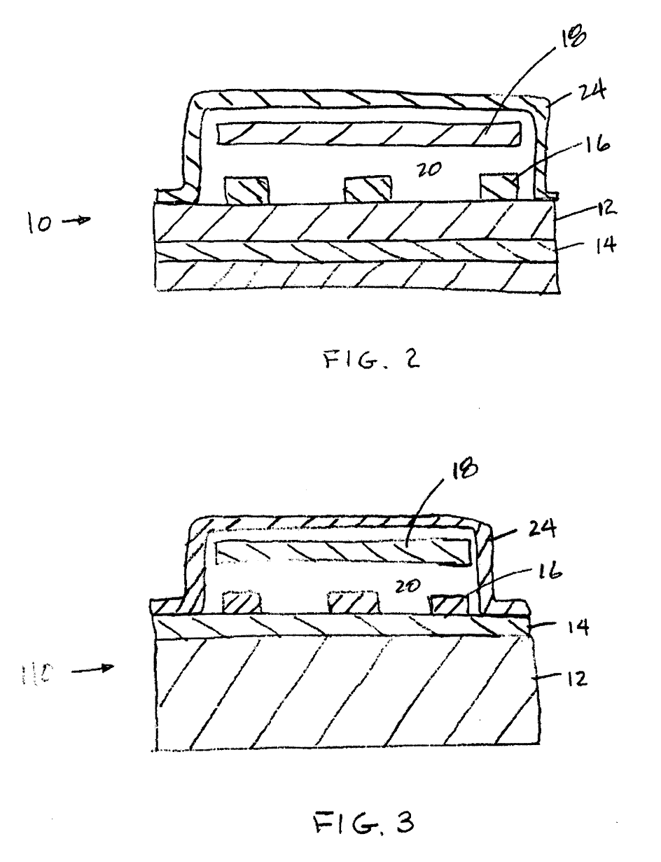

Referring to FIG. 2 there is illustrated a cross-section view of a portion of one embodiment of an electrical device 10. The device 10 comprises a substrate 12. Embedded within the substrate 12 is a low reflectivity layer 14. The substrate 12 substantially surrounds the low reflectivity layer 14. On one side of the substrate 12 is a plurality of first conductors 16 arranged in a plurality of rows (or columns), extending in a first direction. A plurality of second conductors 18 spaced apart from one another are arranged in a direction substantially perpendicular to the first direction. An active material 20 is positioned between the first conductors 16 and the second conductors 18. The entire structure comprising the first conductors 16, second conductors 18 and active material 20 may be enclosed by an enclosure 24.

The substrate 12 can be made of any material, for example, a rigid material such as glass, ceramic, alumina, or it can be a flexible material, for example, a polymeric material. Examples of suitable polymers for the polymeric film may be selected from one or more materials containing essentially polyolefins (e.g., polyethylene or polypropylene); polyesters (e.g., polyethylene terephthalate or polyethylene naphthalate); polyimides; polyamides; polyacrylonitriles and polymethacrylonitriles; perfluorinated and partially fluorinated polymers (e.g., polytetrafluoroethylene or copolymers of tetrafluoroethylene and polystyrenes); polycarbonates; polyvinyl chlorides; polyurethanes; polyacrylic resins, including homopolymers and copolymers of esters of acrylic or methacrylic acids; epoxy resins; Novolac resins; and combinations thereof. When multiple polymeric films are used, they can be joined together with appropriate adhesives or by conventional layer producing processes including known coating, co-extrusion, or other similar processes. The polymeric films generally have a thickness in the range of approximately 12-250 microns (0.5-10 mils). When more than one film layer is present, the individual thicknesses can be much less.

Although the polymeric film(s) may contain essentially one or more of the polymers described above, the film(s) may also include one or more conventional additive(s). For example, many commercially available polymeric films contain slip agents or matte agents to prevent the layers of film from sticking together when stored as a large roll.

The composition of the organic active layer 20 typically depends upon the application of the organic electrical device 10. When the organic active layer 20 is used in a radiation-emitting organic electronic device, the material(s) of the organic active layer 20 will emit radiation when sufficient bias voltage is applied across the organic active layer 20. The radiation-emitting active layer may contain nearly any organic electroluminescent or other organic radiation-emitting materials.

The materials in the organic active layer 20 can be small molecule materials or polymeric materials. Small molecule materials may include those described in, for example, U.S. Pat. No. 4,356,429 (“Tang”) and U.S. Pat. No. 4,539,507 (“Van Slyke”). Polymeric materials may include those described in U.S. Pat. No. 5,247,190 (“Friend”), U.S. Pat. No. 5,408,109 (“Heeger”), and U.S. Pat. No. 5,317,169 (“Nakano”). Exemplary materials are semiconductive conjugated polymers, such as poly (phenylenevinylene), referred to as “PPV,” and polyfluorene. The light-emitting materials may be dispersed in a matrix of another material, with or without additives. The organic active layer generally has a thickness in the range of approximately 40-100 nm.

When the organic active layer 20 is incorporated into a radiation responsive or receiving organic electronic device, the material(s) of the organic active layer 20 may include many conjugated polymers and electroluminescent materials, and photoluminescent materials. Specific examples include poly(2-methoxy,5-(2-ethyl-hexyloxy)-1,4-phenylene vinylene) (“MEH-PPV”) and MEH-PPV composites with CN-PPV. In this type of device, the organic active layer 20 typically has a thickness in a range of approximately 50-500 nm.

A nearly limitless number of materials can be used for the low reflectivity layer 14. The electrical characteristics of the low reflectivity layer 14 can vary from conductive to semiconductive to insulating. A suitable material for a low-reflectivity layer 14 can comprise one or more inorganic materials selected from elemental metals (e.g., W, Ta, Cr, In, or the like); metal alloys (e.g., Mg—Al, Li—Al, or the like); metal oxides (e.g., CrxOy, Fexoy, In2O3, SnO, ZnO, or the like); metal alloy oxides (e.g., InSnO, AlZnO, AlSnO, or the like); metal nitrides (e.g., AlN, WN, TaN, TiN, or the like); metal alloy nitrides (e.g., TiSiN, TaSiN, or the like); metal oxynitrides (e.g., AlON, TaON, or the like); metal alloy oxynitrides; Group 14 oxides (e.g., SiO2, GeO2, or the like); Group 14 nitrides (e.g., Si3N4, silicon-rich Si3N4, or the like); and Group 14 oxynitrides (e.g., silicon oxynitride, silicon-rich silicon oxynitride, or the like); Group 14 materials (e.g., graphite, Si, Ge, SiC, SiGe, or the like); Group 13-15 semiconductor materials (e.g., GaAs, InP, GaInAs, or the like); Group 12-16 semiconductor materials (e.g., ZnSe, CdS, ZnSSe, or the like); any combination thereof, and the like. The term elemental metal refers to a layer that consists essentially of a single element and is not a homogenous alloy with another metallic element or a molecular compound with another element. For the term metal alloys, silicon can be considered a metal. In many embodiments, a metal, whether as an elemental metal or as part of a molecular compound (e.g., metal oxide, metal nitride, or the like) may be a transition metal (an element within Groups 3-12 in the Periodic Table of the Elements) including chromium, tantalum, gold, or the like.

The low reflectivity layer 14 can also be made from one or more organic materials selected from polyolefins (e.g., polyethylene, polypropylene, or the like); polyesters (e.g., polyethylene terephthalate, polyethylene naphthalate or the like); polyimides; polyamides; polyacrylonitriles and polymethacrylonitriles; perfluorinated and partially fluorinated polymers (e.g., polytetrafluoroethylene, copolymers of tetrafluoroethylene and polystyrenes, and the like); polycarbonates; polyvinyl chlorides; polyurethanes; polyacrylic resins, including homopolymers and copolymers of esters of acrylic or methacrylic acids; epoxy resins; novolac resins, organic charge transfer compounds (e.g., tetrathiafulvalene tetracyanoquinodimethane (“TTF-TCNQ”) and the like), any combination thereof, and the like.

Skilled artisans will understand that the thickness of the low-reflectivity layer 14 can be tailored to achieve the desired reflectivity given by the equation below.
2ηd cos(θ)+φ=(m+½)λ, (Equation 2)
where,
η is the refractive index of the selected material at a specific wavelength (λ);
d is the thickness of the layer;
θ is the angle of incident radiation;
φ is the total phase change of the radiation reflected by an ideal reflector at λ;
m is an integer; and
λ is the specific wavelength.

The low reflectivity layer 14 may be a vapor barrier material, or a moisture penetrating layer. As used herein, the term “moisture penetrating” layer shall mean a layer having an oxygen or water vapor transport rate of greater than 1.0 cc/m²/24 hr/atm. Thus, in one non-limiting embodiment, the low reflectivity layer 14 is a transmissive moisture penetrating layer within the substrate 12, which is rigid, such as glass, ceramic, alumina or the like, or which is a flexible material, such as a polymeric material. In another non-limiting embodiment, the low reflectivity layer 14 is a transmissive layer (which may be moisture penetrating) within a rigid substrate 12, such as glass, ceramic, alumina or the like. For each of the above embodiments, a first conductor 16 is on the rigid substrate 12, an active material 20 is on the first conductor 16, and a second conductor 18 is on the active material 20.

Reflectivity is a measure of how much incident radiation is reflected as measured by the intensity of the radiation. The reflectivity of the low-reflectivity layer 14 may not exceed approximately 30 percent (100%*Ireflected/Iincident). Equation 2 can be used to determine the appropriate thickness(es) for a layer(s). Alternatively, Equation 2 may be used to determine an acceptable range of thicknesses for a layer and still achieve low reflectivity. Equation 2 is a sinusoidal function of thickness. Therefore, multiple thicknesses can be used to attain low reflectivity for a specific wavelength. Equation 2 may be used for radiation outside the visible light spectrum, such as infrared or ultraviolet radiation.

For the visible light spectrum, 540 nm may be used for a specific wavelength for determining an appropriate thickness of a low-reflectivity layer, and a metal mirror can be used as an ideal reflector. Other wavelengths can also be used depending on the radiation being contemplated. Theta may be selected to be approximately 45 degrees. Although the calculations can provide a single thickness, a range of acceptable thicknesses may be given for manufacturing purposes. As long as the thickness does not lie outside the range, reasonably acceptable low reflectivity may be achieved.

The low-reflectivity layer 14 may have a thickness that is calculated using the equation above. The low-reflectivity layer 14 may allow significant transmission of radiation within the targeted spectrum to or from an active layer 20, while still achieving an acceptable (low) level of reflectivity. Some trade-off between the transmission and reflectivity for the layer may occur. As the reflectivity is reduced close to zero, the transmission of radiation through the low-reflectivity layer 14 may be degraded. However, the degradation in transmission may not be as severe as the degradation in reflectivity. Therefore, a reflectivity close to zero may reduce transmission by no more than approximately 50 percent. If this transmission is too low, the reflectivity may be increased slightly.

Absorbance of a layer having a substantially uniform composition can be empirically determined and data from absorbance (or transmittance) measurements collected from the empirical tests can be used to generate an equation for absorbance as a function of thickness. Each material may have its own absorbance equation as a function of thickness. Note that absorbance and transmittances are complementary mechanisms. Some of the radiation entering a layer initially may be absorbed and the remainder of the radiation may be transmitted. Skilled artisans may use transmission concepts rather than absorbance concepts, as high absorbance material has low transmission at the targeted wavelength or spectrum.

The reflectivity of each interface between adjacent layers can be determined by the equation below.

$$R = \frac{{I}_{reflected}}{{I}_{incident}} = {( \frac{{η}_{x} - {η}_{y}}{{η}_{x} + {η}_{y}} )}^{2} \qquad ( Equation 3 )$$

wherein, ηx and ηy are the refractive indices of the materials on opposite sides of the interface.

A series of equations for each of the layers and interfaces can be written using the absorbance (for each pass through each layer), the single layer reflectivity (Equation 2) and the interfacial reflectivity (Equation 3) equations. In theory, the number of equations may be very large. However, some simplifying assumptions may be made. For example, each of radiation 1121 and 1122 may be significant compared to radiation 1123. Therefore, radiation 1123 may be ignored. Similarly, radiation 1124 and 1125 may be significant, whereas, the “next reflection” (not illustrated in FIG. 1) from layer 104 being emitted from the device may be insignificant. Further, mirror-like surface 106 may be assumed to reflect all radiation reaching it. If surface 106 is black, it may absorb all radiation.

A computer program using the equations and simplifying assumptions may be run to determine how the Lbackground is affected by the thickness of any one or more layers or by changing the composition of the layers. Lbackground can be the sum of radiation 1121-1125. Note that radiation 1121-1125 may have different intensities and different phases. By changing the thickness(es) and composition(s) of the layer(s), the intensities and phases can be changed to cause destructive interference to reduce Lbackground.

As an alternative to the equations above, any combination of reflectivity and absorbance equations may be used. Many devices may have several layers instead of the two layers as illustrated in FIG. 1. The equations may only focus on one layer or a subset of the layers. Skilled artisans will understand the types and number of equations to be used.

Referring to FIG. 3, there is illustrated a cross-section view of a portion of another embodiment of an electrical device 110. The device 110 illustrated in FIG. 2 is similar to the device illustrated in FIG. 1, but includes a low reflectivity layer 14 on one side of the substrate 12.

The electrical device 10 or 110 can generate electromagnetic radiation, such as light in response to current and/or voltage supplied to the first conductors 16 and second conductors 18. Thus, the device 10 or 110 operates as a display device or an OLED, for example. The electrical device 10 or 110, however, can generate voltage or current in response to light impinging thereon. Thus, the device 10 or 110 operates as a photodetector, photodiode, photoresist, photoconductive cell, photoswitch, phototransistor, phototube or photovoltaic cell. In each of the above devices, the low reflectivity layer 14 must be transmissive in order for the light to be able to be transmitted through the substrate 12 to impinge the active material 20.

Devices that use photoactive materials may include one or more charge transport layers, which are positioned between a photoactive (e.g., light-emitting) layer and a contact layer (hole-injecting contact layer). A device can contain two or more contact layers. A hole transport layer can be positioned between the photoactive layer and the hole-injecting contact layer. The hole-injecting contact layer may also be called the anode. An electron transport layer can be positioned between the photoactive layer and the electron-injecting contact layer. The electron-injecting contact layer may also be called the cathode.

Advantageously, an array of electrical devices has an improved contrast ratio by using a low reflectivity layer. As described above, the low reflectivity layer may be designed by optimizing the thickness or materials at the interfaces of the layer to reduce reflectivity.

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense and all such modifications are intended to be included within the scope of invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims.

What is claimed is:

1. An electrical device comprising:
a substrate comprising a transmissive low reflectivity moisture penetrating layer;
a first conductor on the substrate;
an active material on the first conductor; and
a second conductor on the active material.

2. The device of claim 1 wherein the active material is an organic active material.

3. The device of claim 2 wherein the electrical device is a display device.

4. The device of claim 1 wherein the electrical device is a photodetector device.

5. The device of claim 1 wherein the low reflectivity layer is substantially surrounded by the substrate.

6. The device of claim 1 wherein the low reflectivity layer is disposed on a surface of the substrate between the substrate and the first conductor.

7. An electrical device comprising:
a rigid substrate comprising a transmissive low reflectivity layer;
a first conductor on the rigid substrate;
an active material on the first conductor; and
a second conductor on the active material.

8. The device of claim 7 wherein the active material is an organic active material.

9. The device of claim 8 wherein the electrical device is a display device.

10. The device of claim 7 wherein the electrical device is a photodetector device.

11. The device of claim 7 wherein the rigid substrate is glass, and the low-reflectivity layer is substantially surrounded by the glass substrate.

12. The device of claim 7 wherein the substrate is glass, and the low reflectivity layer is disposed on a surface of the glass substrate between the glass substrate and the first conductor.

13. An electrical device comprising:
a substrate comprising a transmissive low reflectivity layer; the low reflectivity layer having a selected thickness determined by the desired degree of non-reflectance of the desired electromagnetic radiation to be transmitted through the substrate;
a first conductor on the substrate;
an active material on the first conductor; and
a second conductor on the active material.

14. The device of claim 13 wherein the active material is an organic active material.

15. The device of claim 14 wherein the electrical device is a display device.

16. The device of claim 13 wherein the electrical device is a photodetector device.

17. The device of claim 13 wherein the low reflectivity layer is substantially surrounded by the substrate.

18. The device of claim 13 wherein the low reflectivity layer is on a surface of the substrate between the substrate and the first conductor.
